(19) United States
(12) Patent Application Publication
(10) Pub. No.: US 2012/0204478 A1
(43) Pub. Date: Aug. 16, 2012

(54) HEATER AND METHOD FOR HEATING AN ENCLOSURE TO ERADICATE INSECTS

(76) Inventors: JOSEPH GERE, Freehold, NJ (US); John W. Emery, Hinckley, OH (US)

(21) Appl. No.: 13/398,252

(22) Filed: Feb. 16, 2012

Related U.S. Application Data
(60) Provisional application No. 61/595,770, filed on Feb. 7, 2012.
(60) Provisional application No. 61/463,331, filed on Feb. 16, 2011.

(51) Int. Cl. A01M 1/00

(52) U.S. Cl. 43/132.1

(57) ABSTRACT

A heater for eradicating insects can include an elongated housing that includes a sidewall that extends between spaced apart first and second ends. The housing includes an inlet at the first end configured to intake ambient air and an outlet extending radially through the sidewall adjacent the second end. A fan within the housing includes blades and a motor. The blades are located between the motor and the inlet, and the motor configured to rotate the blades to move the ambient air from the inlet toward the second end of the housing. A plurality of heating elements are mounted within the housing at a radial position that is adjacent the sidewall and at an axial position that is near the outlet. A controller is configured to control the fan and the plurality of heating elements to produce outflow of heated air from the outlet with a predetermined temperature and for a duration sufficient to eradicate insects.

### CROSS-REFERENCE TO RELATED APPLICATION

This application claims the benefit of U.S. Provisional Application No. 61/595,770 filed Feb. 7, 2012 and entitled BEDBUG CHASER HEATER, and of U.S. Provisional Application No. 61/463,331, filed Feb. 16, 2011 and entitled ELECTRIC BEDBUG HEATER, each of which applications are incorporated herein by reference in their entirety.

### TECHNICAL FIELD

This disclosure relates to a heater and to a method for heating an enclosure to eradicate insects.

### BACKGROUND

Bedbugs and other insect infestations are spreading throughout the world and in particular the United States. They can cause both economical and psychological damage. Eradication of insects, including bed bugs, can involve a combination of pesticide and non-pesticide approaches. Resistance to pesticides has increased significantly over time. There is also a significant concern of negative health effects from the use of pesticides. Additionally, several mechanical approaches have been recommended such as may include vacuuming up the insects and heat treating objects as well as rooms.

### SUMMARY

This disclosure relates to a heater and to a method for heating an enclosure to eradicate insects.

As one example, a method for eradicating insects in an enclosure can include placing a heater in the enclosure and activating the heater. The heater can include an elongated housing includes a sidewall that extends substantially longitudinally between spaced apart first and second ends. As used herein, the term “substantially” is intended to allow some amount of variations in a quality or arrangement of the term that the term modifies, such as including design and/or manufacturing variations (e.g., about 10%). The housing can include an inlet at the first end configured to intake air and an outlet extending through the sidewall adjacent the second end. A plurality of heating elements are disposed within the housing in a distributed arrangement near the sidewall, with each of the heating elements extending substantially axially relative to the sidewall. A fan is located to push air from the inlet across the heating elements to provide for outflow of heated air from the outlet. The heater thus can be controlled to heat the air within the enclosure to a predetermined temperature for a predetermined time sufficient to eradicate insects within the enclosure in response to the outflow of heated air. After the predetermined time, the heater can be deactivated.

As another example, a heater for eradicating insects can include an elongated housing that includes a sidewall that extends between spaced apart first and second ends. The housing includes an inlet at the first end configured to intake ambient air and an outlet extending radially through the sidewall adjacent the second end. A fan within the housing includes blades and a motor. The blades are located between the motor and the inlet, and the motor configured to rotate the blades to move the ambient air from the inlet toward the second end of the housing. A plurality of heating elements are mounted within the housing at a radial position that is adjacent the sidewall and at an axial position that is near the outlet. A controller is configured to control the fan and the plurality of heating elements to produce outflow of heated air from the outlet with a predetermined temperature and for a duration sufficient to eradicate insects.

### BRIEF DESCRIPTION OF THE DRAWINGS

FIG. 1 illustrates a perspective view of an example heater.

FIG. 2 is a top elevation of the example heater of FIG. 1.

FIG. 3 is a side elevation of the example heater of FIG. 1.

FIG. 4 is a cross-sectional of an example heater view taken along line 4-4 in FIG. 3.

FIG. 5 is a cross-sectional of an example heater view taken along line 5-5 in FIG. 3.

FIG. 6 is a cross-sectional of an example heater view taken along line 6-6 in FIG. 3.

FIG. 7 is a cross-sectional of an example heater view taken along line 7-7 in FIG. 2.

FIGS. 8A and 8B depict an example of a resistive heating element that can be utilized in a heater.

FIG. 9 is a block diagram depicting an example of a heating circuit that can be implemented.

FIG. 10 is a flow diagram depicting an example of method for heating an enclosure.

### DETAILED DESCRIPTION

This disclosure relates to a heater and to a method for heating an enclosure to eradicate insects. For example, the heater and methods disclosed herein can be utilized to eradicate bed bugs, such as including louse, mahogany flat, crimson rambler, heavy dragoon, chinche bug, and redcoat. As disclosed herein, the heater can be placed in the enclosure, such as a room, vehicle or other enclosed or enclosable spaces that might be subjected to insect infestation. For example, such rooms can be located in a variety of structures that hotel rooms, college dormitories, nursing homes, office buildings, schools and daycares, hospitals, movie theaters as well as others. The heater is activated (e.g., via a switch) which causes a fan to force air from an inlet through a generally cylindrical housing to provide heated air from an outlet. Because of the configuration and arrangement of heating elements distributed within the housing, the difference in temperature for ambient air at the inlet and heat air at the outlet can exceed other types of heaters. By utilizing an efficient electric fan (e.g., operating at 208 V), the heater can provide for increased volumetric flow rate and thus increased heating relative many existing approaches. For example, the heater can provide air with flow rates greater than 2500 CFM, such as even equal to or greater than 3000 CFM.

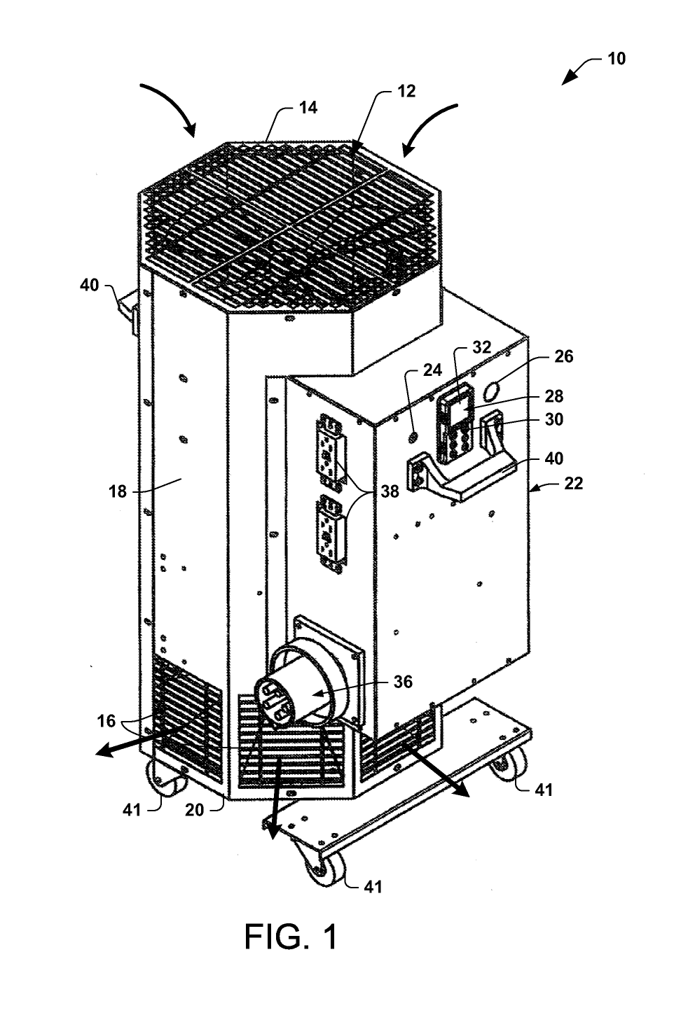

FIGS. 1, 2 and 3 depict an example of a heater 10 that can be utilized for heating a room to a temperature sufficient to eradicate insects, such as about 130° to about 140° Fahrenheit. The heater 10 includes an inlet 12 located at a first end 14, demonstrated in the example of FIG. 1 as the upper end. The inlet 12 can include a grate or other perforated type of covering (e.g., a screen or grill) to prevent objects, such as debris or fingers, from entering the housing yet still allow for the free flow of air into the heater via the inlet 12. The inlet 12 is spaced apart from an outlet 16 by a corresponding sidewall 18 having a generally cylindrical configuration. For example, the outlet 16 can provide for full radial exhaust through the sidewall (e.g., heated airflow from all 360° around the sidewall 18).

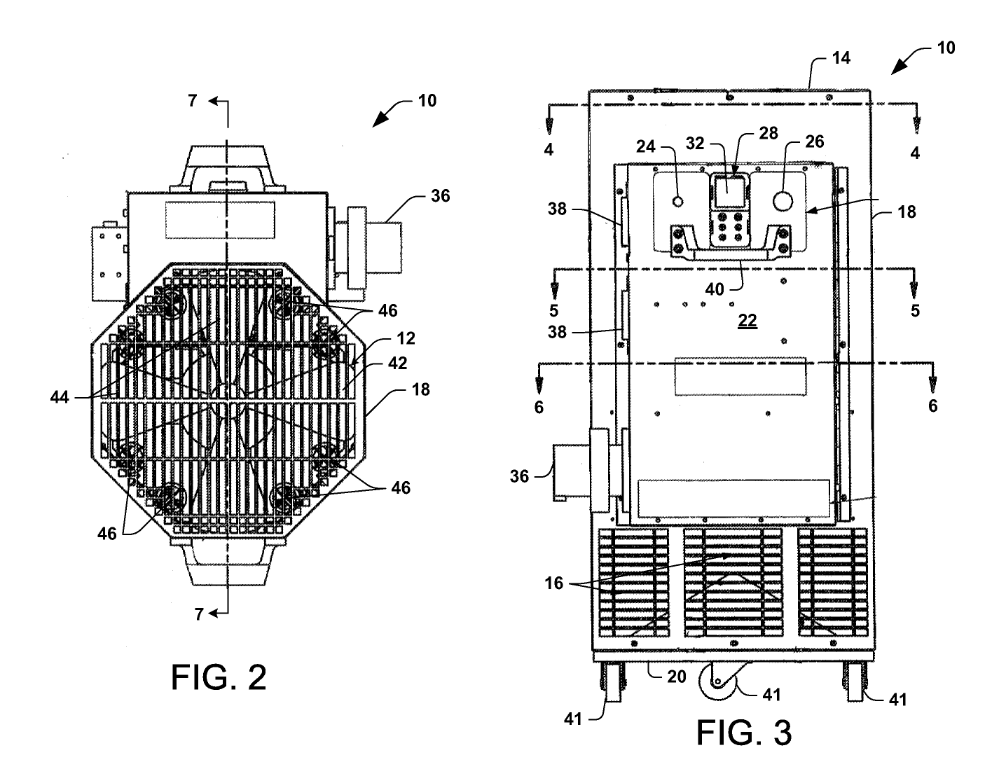

As represented in the example of FIGS. 1 and 2, the sidewall 18 of the heater 10 has a non circular (not smooth) interior. For instance, the sidewall 18 can have an octagonal cross sectional shape as demonstrated in FIG. 2, which includes flat sides connected by vertices. In other examples, different cross-sectional shapes can be utilized. The sidewall 18 extends from the first end 14 to a second (e.g., bottom) end 20. The outlet 16 extends through the sidewall 18, such that heated air can flow radially outwardly from the outlet 16 of the heater 10. The outlet can include a corresponding vented grating along the perimeter, such as to help direct the air outwardly from the heater as well as to prevent objects from insertion into the heater. The heater 10 can also include a control panel 22 that includes electronics and controls for operating the heater. In one example, the heater 10 can be about 30 to about 40 inches long between the ends 14 and 20 and the sidewall 18 can have a diameter of about 12 to about 20 inches.

As shown in FIGS. 1 and 3, the control panel 22 can include a switch 24 that operates to activate and deactivate the heater 10 in response to a user input. The control panel 22 can also include a light (e.g., a LED or other form of lamp) 26 that is utilized to identify if the heater is functioning within expected operating parameters. A control unit 28 can include one or more switches 30, such as may be utilized to set programmable operating parameters (e.g., set point temperature, duration of heating and the like) for the heater 10. The control unit 28 can also include a display (e.g., an LCD or other form of display) that can facilitate setting operating parameters for the heater as well as displaying messages to the user during operation. For instance, during a setup mode, the display 32 can cooperate with the control unit to provide a human machine interface to set operating parameters. The display can also provide status information (e.g., current temperature, set point temperature, timing information, warnings etc.) during operation.

The control panel 22 also includes a power input 36 such as including the plurality of electrically conductive plugs or other means for connecting to a source of power. In one example, the heater 10 can connect a three phase power source of 208 volts and 60 Hz for receiving input power. For instance, the power input 36 can include three line voltages, a neutral conductor and an electrical ground conductor. The source of power can be provided via a generator, power outlets or other sources of power. In other examples, different power sources can be utilized for supplying electrical energy for operation of the heater 10.

The control panel 22 may also include one or more power outlets 38 for providing output power for auxiliary equipment that may be utilized in combination with the heater 10. As an example, the power outlets 38 can include a plurality of female connectors (e.g., ground fault interrupt outlet receptacles) for providing 120 volts AC single phase power, which can be derived from the three phase power without use of a transformer. Depending on application requirements and room size, one or more auxiliary circulating fans can be electrically connected to the power outlets 38 of the heater 10. Such fans can be utilized to distribute the heated air through an enclosure. As a result, the need for additional cables, connections, extension cords and the like can be eliminated, thereby reducing potential hazards (e.g., a person tripping over a cable, electrical shock and the like).

In order to facilitate movement and installation of the heater within an enclosure, the heater may include one or more handles 40 that can extend outwardly from the corresponding sidewall 18. For example, the pair of handles 40 can extend outwardly from diametrically opposed sides of the heater 10, such as one handle attached to extend outwardly from the sidewall 18 and a second handle extending outwardly and attached to the housing at the control panel 22. Additionally, the heater 10 may include a set of wheels 41, such as may be rotatable caster wheels, to facilitate sliding along a variety of surfaces including carpet, wood, concrete or the like.

As demonstrated in the example of FIG. 2, the heater 10 includes a fan 42 to move air from the inlet 12 through the heater and out the outlet 16. As used herein, the fan can be implemented as any means for moving air from the inlet and through the housing 18, such as an axial fan, centrifugal fan or the like. The example heater 10 shown in the figures includes an axial fan 42 that includes having a plurality of fan blades 44 that rotate according to rotation of a shaft to which they are connected. The corresponding fan blades 44 are positioned near the inlet 12 of the heater and are oriented to pull ambient air into the housing via the inlet 12. Additional information regarding the fan 42 is demonstrated in various cross sectional views disclosed herein.

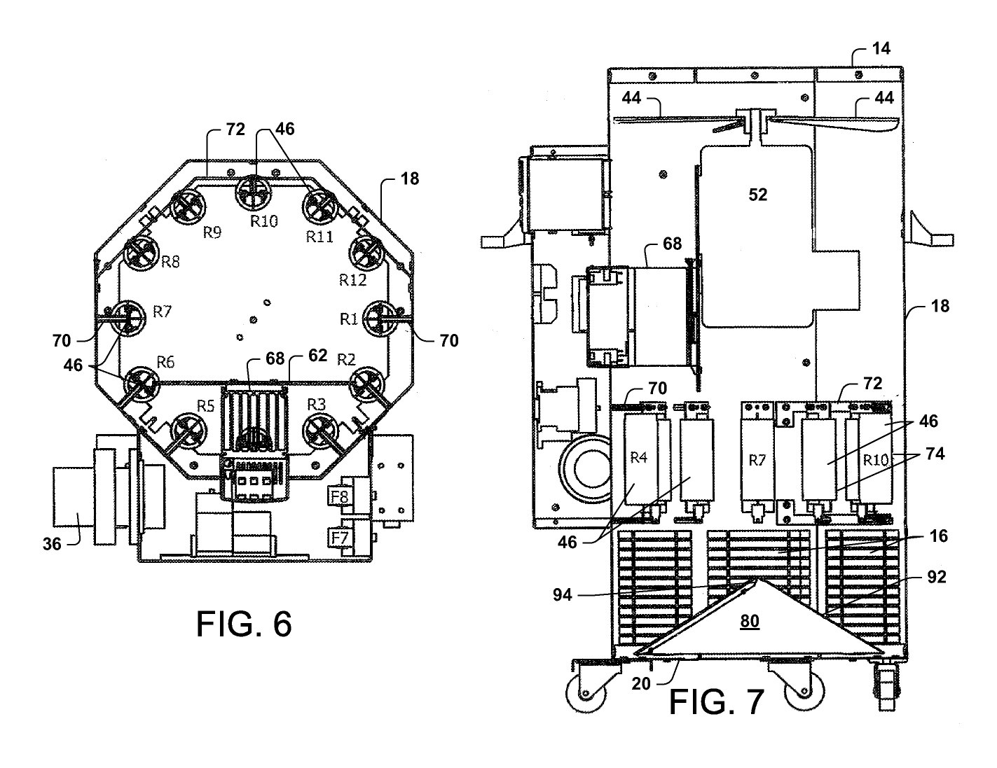

Also depicted in FIG. 2 are a plurality of heating elements 46. The heating elements 46 can be fixed relative to the sidewall 18 and disposed in a generally evenly-spaced apart arrangement fixed to the interior of the sidewall 18. For the example of the octagonal cross-sectional configuration for the sidewall 18, there may be one or two heating elements disposed on each edge of the octagon shape (see e.g., FIG. 6). As disclosed herein, the heating elements 46 are disposed between the fan 42 and the air outlet 16. In one example, the heater can be configured such as to maximize the distance between the fan blades 44 and the heating elements 46. The heating elements can also extend longitudinally in a direction that is substantially parallel to the sidewall. Such configuration enables air to be heated quickly to a desired treatment temperature than other types of heating units. For example, due to the arrangement of heating elements 46, the heater 10 can provide a large temperature difference between ambient air at the inlet 14 and heated air at the outlet, such as about 50° F. or greater (e.g., even greater than about 100° F.). These and other aspects of the interior of the heater will be better appreciated with respect to the various cross sectional views disclosed herein.

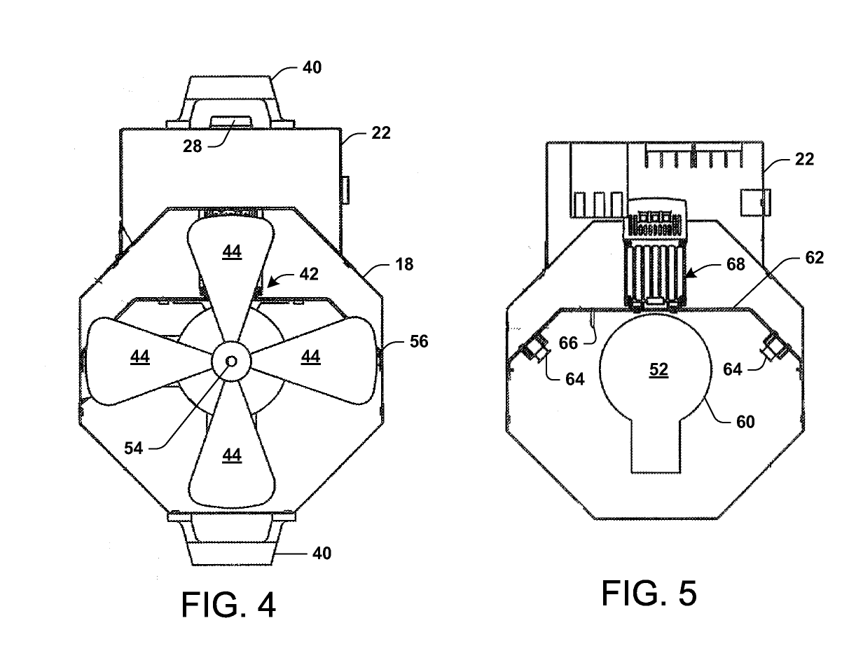

FIG. 4 depicts a cross sectional view taken along line of 4-4 of FIG. 3 demonstrating an example configuration for the fan 42. The example fan 42 in FIG. 4 depicts four blades 44 in which each adjacent pair of blades extends radially outwardly from the central longitudinal axis, corresponding to a rotating shaft 54 located at the fan's axis of rotation. In this example, adjacent blades 44 can be spaced apart from each other at an angle of about 90°. Each of the fan blades 44 extends radially outwardly from the shaft and terminates in a corresponding distal end (e.g., tip) 56. For example, the distal end 56 can be generally flat, such as having an edge that is substantially normal to radial line through the fan blade). The length of the normal edge at 56 can be greater than about one-half of the length of the face of each of the edges of the octagon sidewall 18, for example. The flat distal end 56 of the fan blades further permits a small clearance between the distal end and the interior sidewall 18. Additionally, the flat distal end (instead of being rounded) 56 can provide each of the blades with a greater surface area to increase the movement of air from the inlet through the sidewall. Other numbers and configurations of the blades 44 can also be utilized in the heater 10.

The fan 42 also includes a fan motor 52 that can be arranged below the blades 44, such as extending axially between the blades and the heating elements 46 in a central portion of the housing. In this way, airflow caused by rotation of the fan blades 44 can flow over the body of the motor 52 to help cool the fan motor. In addition to providing cooling for the motor 52, the alignment of the motor body 52 at a central portion of the housing 18 (e.g., spaced radially inwardly from the sidewall 18) helps deflect airflow outside of the central portion of the housing against the interior portion of the sidewall 18 where the heating elements 46 (e.g., see FIGS. 2 and 6) reside. The position of the motor 52 and longitudinally extending vertices along the sidewall 18 thus contribute to the swirling, cyclonic airflow within the housing defined by sidewall. The arrangement of the fan 42 and fan blades 44 and the housing 18 can be referred to as a tube-axial fan design, which moves air with increased swirl (e.g., cyclonic airflow) within the housing.

By way of further example, the motor 52 can be operated by the three phase power that is received at the power input 36. For instance, the input power received at 36 can be three-phase 208 V. Circuitry in the control panel 22 thus can supply the full three-phase 208 V to operate the fan motor 52. Such power can enable the motor 52 rotate the blades 44 to produce greater than 2,000 CFM of airflow, such as in the range of 2,500 to 3,500 (e.g., about 3,000 CFM).

FIG. 5 demonstrates a sectional view of the heater 10 taken along the line 5-5 of FIG. 3. In the example of FIG. 5, the fan motor 52 has a housing 60 having a generally keyhole shape, which houses an electric motor and impeller. A mounting bracket 62 extends between opposed sides of the housing. Corresponding temperature switches 64 are mounted to the bracket 62 at spaced apart locations within the housing. Each of the switches 64 can be configured to either activate or deactivate in response to temperature within the housing at the switch being greater than a predetermined threshold (e.g., about 160°). The switches 64 can be electrically connected to the respective circuitry located within the control panel 22. A temperature sensor (e.g., a thermocouple) 66 can also be mounted to the bracket 62 for providing an indication of the temperature within the housing at the location of the sensor. A power controller 68 can also extend into the housing 18 and be mounted to the bracket 62. The controller 68 can be electrically connected to the fan motor 52 and extend into the sidewall 18 from the control panel 22. The controller can include a housing that includes vents to provide for substantially free flow of air from the fan into the housing prior to being heated. Thus, the fan 42 can provide ambient air into the controller 68 to help cool the circuitry that comprises the controller 68 (e.g., power switches, such as SCRs, and other circuitry). The controller 68 can be coupled to additional power control circuitry within the control panel 22 for receiving the three phase electrical power utilized for driving the heating elements. The circuitry in the controller 68 can be configured, for example, to drive the heating elements 46 based on temperature sensed by the sensor 66 as to regulate the temperature within the housing.

The arrangement of the heating elements 46 will be better appreciated with reference to FIG. 6, which is a cross sectional view taken along the line 6-6 of FIG. 3. In the example of FIG. 6, each of the heating elements 46 is demonstrated as a resistive heating element labeled R1 through R12. While twelve such heating elements are demonstrated in this example, there can be greater than or less than twelve. The heating elements 46 are affixed to the sidewall 18 through corresponding connector brackets, which can vary depending upon the location of the respective heating elements within the housing. As shown, the connector brackets 70 and 72 are configured to hold each of the heating elements in a desired longitudinal orientation that is substantially parallel with and spaced apart from the sidewall 18. The controls in the control panel 22 can drive each of the resistive heating elements 46 with current (e.g., evenly proportioned among the heating elements), such as to provide an aggregate power of about 20 kW or greater. This can be achieved in response to input power received via a single three-phase power input at 36.

As a further example, each of the resistive heating elements R1 through R7 can be individually connected to the sidewall 18 via the corresponding connector brackets 70. The resistive heating elements R8 through R12 are connected to a common bracket 72. In other examples, different connector bracket configurations can be utilized to attach multiple resistive heating elements to the sidewall. Each of the resistors can also be electrically connected to the controller 68, which drives the resistors with current to cause heating.

As demonstrated in the example of FIG. 7, each of the resistive heating elements 46 can be configured with a longitudinally extending resistive body portion 74 that extends substantially parallel to the axis of the sidewall 18. Thus, the longitudinal body portion 74 extends in the direction of airflow. Each adjacent pair of the resistive heating elements 46 can be spaced apart from each other by an air gap, which that can be substantially uniform to facilitate to the flow of air around and over the respective heating elements.

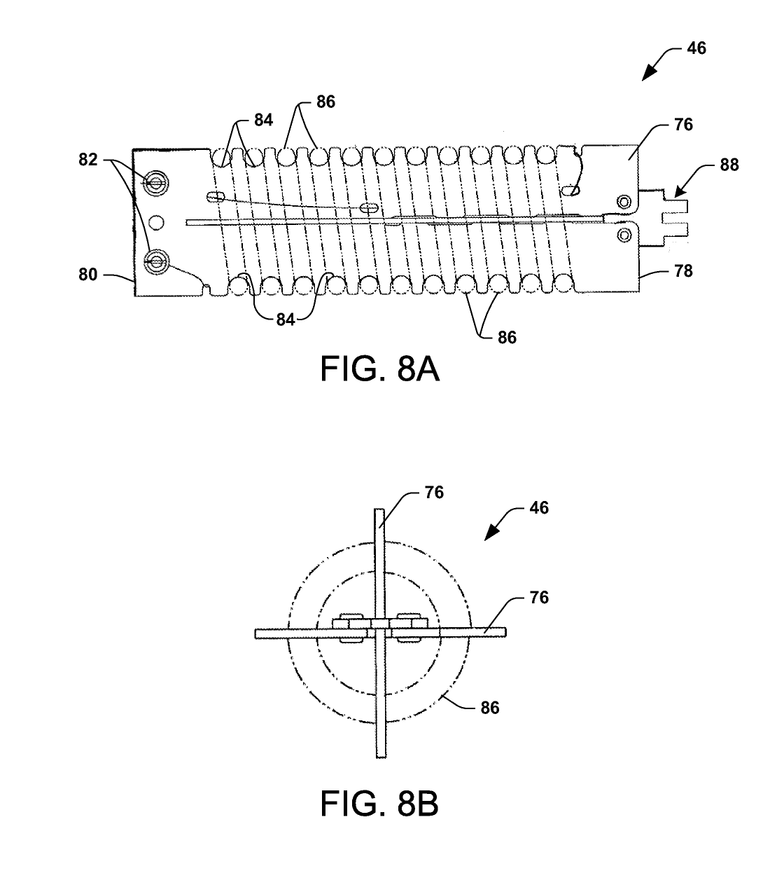

Referring to FIGS. 8A and 8B, the resistive body portion 74 of each heating element can be formed of a coil of an electrically conductive material. For example, each resistive heating element 46 can include an elongated frame 76 that extends between spaced apart end portions thereof 78 and 80. The frame 76 can include a plurality of spokes that extend from a central hub, such as to provide a substantially plus-shape cross sectional configuration, such as shown in FIG. 8B. The plus-shape configuration thus provides spaces between adjacent spokes provide for the substantially free flow of air therethrough and along radially inner and outer surfaces of the respective coils to facilitate heating of the air. The frame 76 can be formed of a substantially rigid electrically insulating material, such as mica. Other insulators can also be utilized for the frame 76, such as glass, ceramics or the like.

The bracket 76 can include apertures 82 that can be utilized to fasten the bracket 76 relative to sidewall by means of the connector brackets 70 and 72 (e.g., via screws or other fasteners). As depicted in the example of FIG. 8A, an exterior edge of each of the plus-shaped bracket members can include slots (e.g., receptacles) 84 formed therein dimensioned and configured for receiving the electrically conductive wire 86. Thus, the slots 84 provide a winder to facilitate winding the wire 86 around the frame 76 to provide an increased surface area for the length of a coil that can function to convert electrical current to heat.

One end of the connector (e.g., at end 78) can include an electrical connector 88, which can be plugged into a corresponding receptacle or otherwise connected to receive electrical current from the controller 68. As one example, the electrically conductive wire can be formed of a chromium alloy material or other electrically conductive material, such that the length of the conductor around the frame 76 provides the heating element with a predetermined resistance. For example, the resistance of each heating element 46 can be in the range of about 20Ω to about 30Ω. In addition to providing desired heating, the conductive wire can facilitate cooling post treatment.

Referring back to FIG. 7, the heater 10 can also include a deflector 90 at the bottom end 20 within the housing that operates as an air diffuser. The deflector 90 can be configured to help direct the airflow from the fan radially outward through the vented outlet 16, as disclosed herein. As one example, the deflector 90 can have a substantially conical surface 92 that extends from a portion that is affixed to the bottom end 20 and terminates in a corresponding apex 94, which may be located at approximately a mid-axial location of the outlet 16. The exposed sidewall 92 of the deflector 90 can have a circular configuration. Alternatively it can have a configuration with triangular side surfaces separated by respective vertices between, such as having an equal number of surfaces and vertices as the sidewall 18 of the heater. As yet another alternative, the deflector 90 may have different numbers of vertices and side edges than the sidewall 18.

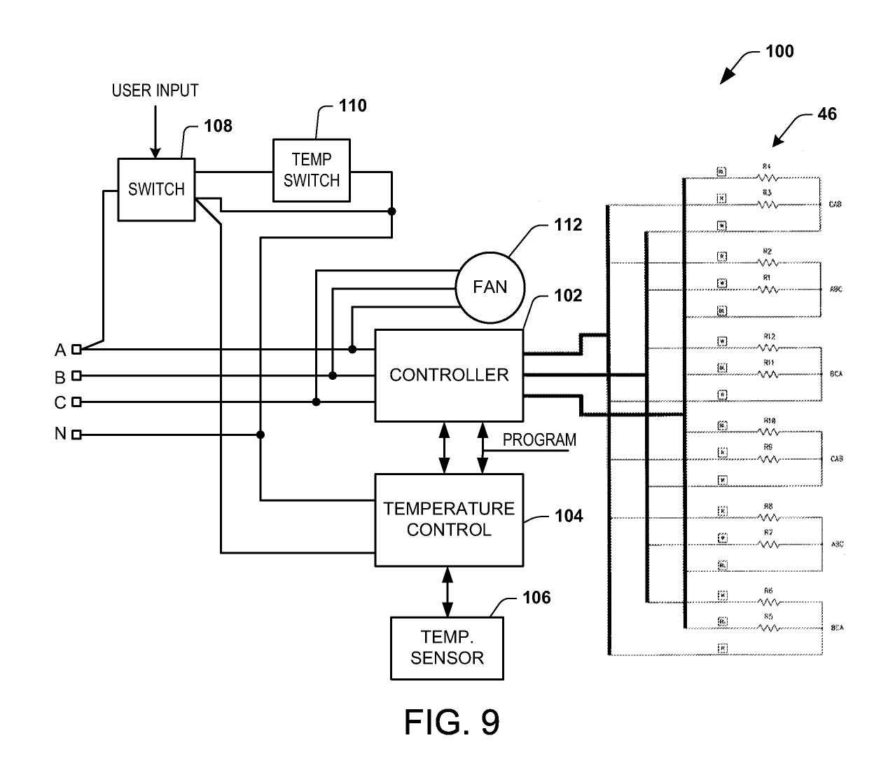

FIG. 9 depicts an example of a block diagram of a heater system 100. In the example of FIG. 9, the heater system 100 includes a controller 102 that is connected to drive a plurality of heating elements 46 demonstrated as R1 through R12. While twelve heating elements are being demonstrated in this example, different numbers of heating elements can be utilized, such as depending upon the size of the housing and the relative size of the heating elements themselves.

In the example of FIG. 9, the controller 102 provides three phase output power, based on three-phase input power (e.g., 208 V AC, 60 Hz) from the corresponding power supply to which the input (e.g., input 36 of FIG. 1) is connected. The power inputs are demonstrated as including line voltages A, B, and C and a neutral connection N. The controller 102 can include a switching network for selectively driving the respective heating elements 46 with corresponding three phase power. The controller 102 is also connected to a corresponding temperature control 104. The temperature controller 104 receives an input from a corresponding temperature sensor 106, such as a thermocouple or other temperature sensing device. The temperature controller 104 can also receive power (e.g., 110 V AC from a line-neutral connection). The controller 102 and/or the temperature control 104 can be programmed to control operation thereof, such as indicated by a program input.

One or more input switches 108 can also be connected between the line voltage and the temperature control 104 for selectively activating and deactivating the heater system 100 such as in response to a user input. The switch 108 thus can activate the temperature control 104 and the heater in response to a user input. One or more thermal switches (e.g., corresponding to the switches 64) 110 can also be utilized to disconnect the temperature controller in response to the temperature exceeding a predetermined temperature threshold, as disclosed herein. A corresponding fan motor 112 can also be coupled to the line voltages for supplying power to the fan. Temperature switches 110 can also be connected in series with the switch 108 for selectively deactivating the control power to the temperature controller in response to temperature exceeding the predetermined threshold as disclosed herein. One or more corresponding indicator lights or other controls may also be connected in series with the temperature switches for indicating whether or not the heating elements are activated. The temperature control 104 may be coupled to the controller 102 for communicating temperature information such that the controller 102 can control the heating element based upon the temperature detected by the temperature control. Various fuses can also be implemented to protect the circuitry in the heater system 100. Additionally, one or more power outlets (e.g., power outlets 38 of FIG. 1) can be electrically connected to one of the line voltages and neutral to provide 110 V AC power for accessories, such as additional circulating fans (not shown).

In view of the foregoing structural and functional features, the heater can be constructed of a size that is smaller and lighter weight, and more easily transported (e.g., by a single person) than many existing heaters for eradicating insects. Additionally, 208 V three-phase electrical power allows for efficiencies in converting electrical energy to heat via the heating elements. Such input power also enables use of power outlets integrated with the housing such that accessories can be connected directly to the heater.

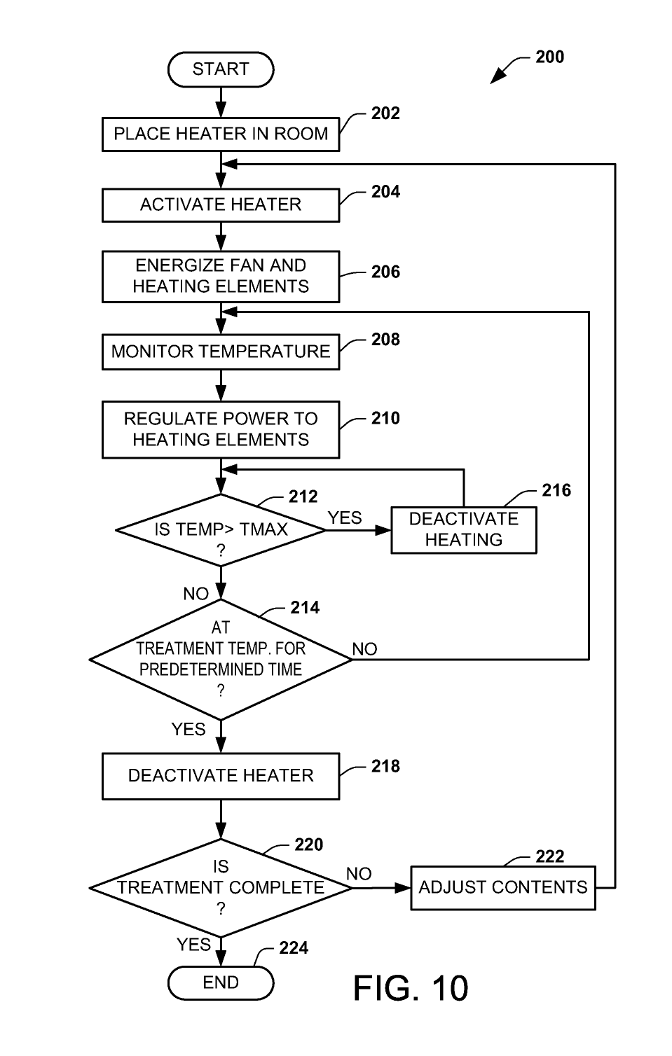

An example method will be better appreciated with reference to FIG. 10. While, for purposes of simplicity of explanation, the method is shown and described as executing serially, it is to be understood and appreciated that the method is not limited by the illustrated order, as parts of the method could occur in different orders and/or concurrently from that shown and described herein.

FIG. 10 illustrates an example method 200 for heating a room to eradicate insects such as bed bugs. Prior to applying heating, the method can include several preparatory steps. For example, the enclosure (e.g., room) to be treated can be prepared, such as by adjusting the furniture to positions to maximize exposure to heat. In the example of FIG. 10, the method begins at 202 in which the heater is place in an enclosure for treatment. The heater is connected to a source of power, such as can be three phase 208 V source of AC power. The heater can be programmed to operate according to application requirements. This can be a default setting or it may include a custom setting, such as can include a temperature and/or duration.

One or more auxiliary fans can be electrically connected to heater (e.g., via power outlets 38) and place in manner that enhances forced convection of the air from the heater. Additionally, wireless temperature sensors can be positioned throughout enclosure to facilitate monitoring temperature throughout the enclosure. Each wireless temperature sensor can be configured for sensing temperature and sending the sensed temperature data to a remote site. The remote site can be located near the enclosure (e.g., a truck or another room) or be at a greater distance and receive the temperature data via a communications network. The remote site can include a receiver for receiving the sensed temperature data to facilitate monitoring of the area being heated.

At 204, the heater is activated, such as in response to a user input via a switch (e.g., switch 24) or other user interface device. At 206, the fan and heating elements are energized, such as in response to the activation at 204. At 208, temperature can be monitored. The temperature can be monitored by an internal temperature sensor (e.g., sensors 66, 64) and/or one or more external temperature sensors (e.g., wireless sensors) distributed within the enclosure being treated. At 210, power to the heating elements can be regulated to meet heating requirements, such as corresponding to a programmed treatment temperature (e.g., about 130° F.) for the enclosure. The treatment temperature can vary depending on the types of insects being eradicated. The heating elements can be configured as disclosed herein (e.g., see FIGS. 6, 7 and 8) such that heating to the treatment temperature is facilitated. The regulation at 210 can be based on a temperature signal (e.g., from the sensor 66), as monitored at 208.

At 212, a determination can be made as to whether the temperature exceeds a maximum temperature. The maximum temperature can be an internal temperature within the heater (e.g., about 160° F.) above which may result in a safety concern. If the temperature does not exceed the max temperature, the method can proceed to 214. At 214, another determination can be made as to whether the enclosure has been heated to the treatment temperature for at least predetermined time (e.g., a treatment temperature and time sufficient eradicate target insects). The determination at 214 can be implemented by controls within the heater, it can be a manual decision by a user monitoring the room (e.g., based on temperature data sent via wireless sensors in the room) or as a combination of automatic (e.g., computer implemented) and manual determinations. If the determination at 214 is negative, indicating that further heating treatment is required, the method returns to 208. If at 212, the sensed temperature has exceeded a threshold, the method proceeds to 216 to deactivate heating. A warning signal (e.g., audible and/or visual indicator) can be provided to alert the user of the condition. This can include reducing or terminating electrical current to the heating elements until the sensed temperature is sufficiently below the threshold. Alternatively, the method can proceed to 220 in which the heater itself can be deactivated, such as to require manual intervention.

Returning to 214, if the enclosure has been heated to the treatment temperature for at least predetermined time, the method can proceed from 214 to 218. At 218, a determination can be made as to whether the treatment method is complete. This can be a manual decision, an automatic (e.g., computer implemented) determination or a combination thereof. If the treatment has not completed for the enclosure, the method can proceed to 220 and the contents of the enclosure can be adjusted. This can include moving furniture and/or fixtures to facilitate treatment in a next heating phase. From 220, the method can return to 208 to repeat the process from 208 through 218. Once it is determined at 218 that the treatment process is complete, the method can proceed to 222 and the heater can be deactivated. The deactivation can include disconnecting power to fan and heating elements by corresponding controls, such as in response to turning off the activation switch. From 22, the can end at 224.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A method for eradicating insects in an enclosure, comprising:
placing a heater in the enclosure;
activating the heater, the heater comprising:
an elongated housing includes a sidewall that extends substantially longitudinally between spaced apart first and second ends, the first end including an inlet configured to intake air, an outlet extending through the sidewall adjacent the second end;
a plurality of heating elements disposed within the housing in a distributed arrangement near the sidewall, each of the heating elements extending substantially parallel to the sidewall; and
a fan within the housing between the heating elements and the inlet, the fan pushing the air from the inlet across the heating elements to provide for outflow of heated air from the outlet;
controlling the heater to heat the air within the enclosure to a predetermined temperature for a predetermined time sufficient to eradicate insects within the enclosure in response to the outflow of heated air; and
deactivating the heater after the predetermined time.

2. The method of claim 1, wherein a difference between a temperature of air taken in at the inlet and a temperature of the heated air at the outlet is greater than 50 degrees Fahrenheit.

3. The method of claim 1, wherein each of the plurality of heating elements comprises a resistive heating element having an elongated body extending substantially parallel with an axis of the housing, the controlling further comprising providing electrical energy to each of the resistive heating elements to convert the electrical energy to heat.

4. The method of claim 3, wherein each of the plurality of heating elements further comprises an electrically conductive coil around an electrically insulating frame, the coil having a longitudinal axis extending through the coil, the electrically insulating frame being fixed relative to the sidewall such that the axis of each coil is substantially parallel with the axis of the housing.

5. The method of claim 4, wherein the plurality of heating elements are evenly distributed in a substantially circular arrangement mounted adjacent to but spaced apart from the sidewall of the housing, each adjacent pair of heating elements being spaced apart from each other in the circular arrangement by respective gaps to facilitate heating air movement caused by operation of the fan.

6. The method of claim 5, wherein the insulating frame comprises a plurality of elongated spokes to support the coil in a generally cylindrical configuration that is substantially parallel with the housing, such that spaces between adjacent spokes provide for substantially free flow of air therethrough and along an inside surface of the respective coils to facilitate heating of the air.

7. The method of claim 1, wherein the fan comprises a motor mounted within the housing between blades of the fan and an axial location corresponding to the heating elements, the sidewall being spaced apart from and circumscribing the motor,
wherein the heating elements are mounted near the sidewall outside of a radial extent of the motor,
wherein the activation causes the fan to move the air from the inlet over the motor, and toward the sidewall and over the heating elements.

8. The method of claim 1, further comprising sensing temperature within the housing, the controlling being based on the sensed temperature within the housing.

9. The method of claim 1, wherein the sidewall comprises a polygonal cross-sectional shape having edges and vertices that help to direct swirling air from the fan over the heating elements.

10. The method of claim 1, wherein the heater comprises a conical deflector at the second end within the housing to divert heated air radially outwardly through the outlet in the housing.

11. A heater for eradicating insects, comprising:
an elongated housing includes a sidewall that extends substantially longitudinally between spaced apart first and second ends, the first end including an inlet configured to intake ambient air, an outlet extending radially through the sidewall adjacent the second end;
a fan within the housing, the fan comprising blades and a motor, the blades located between the motor and the inlet, the motor configured to rotate the blades to move the ambient air from the inlet toward the second end of the housing;
a plurality of heating elements mounted within the housing at a radial position that is adjacent the sidewall and at an axial position that is near the outlet; and
a controller configured to control the fan and the plurality of heating elements to produce outflow of heated air from the outlet with a predetermined temperature and for a duration sufficient to eradicate insects.

12. The heater of claim 11, wherein each of the plurality of heating elements comprises a resistive heating element having an elongated body extending substantially parallel with an axis of the housing, the controller configured to provide electrical energy to each of the resistive heating elements to convert the electrical energy to heat.

13. The heater of claim 12, wherein each of the plurality of heating elements further comprises:
an electrically insulating frame that is fixed relative to the sidewall; and
an electrically conductive coil wound around the frame, the coil having a longitudinal axis extending through the coil substantially parallel with a longitudinal axis of the housing.

14. The heater of claim 13, further comprising brackets configured to attach each of frames to the sidewall of the housing such that the heating elements are spaced apart from the sidewall of the housing to provide air gaps between adjacent pairs of the heating elements and between the sidewall and the heating elements to facilitate movement of air from the fan across exposed surfaces of the respective coils.

15. The heater of claim 13, wherein the frame comprises a plurality of elongated spokes to support the coil in a generally cylindrical configuration that is substantially parallel with the housing, such that spaces between adjacent spokes provide for substantially free flow of air therethrough and along radially inner and outer surfaces of the respective coils to facilitate heating of the air.

16. The heater of claim 11, wherein the motor of the fan includes a central body portion that is mounted axially within the housing between the blades of the fan and an axial location corresponding to the heating elements, the central body portion of the motor having a radially outer extent that is centrally located within the housing spaced radially inwardly apart from the sidewall, the heating elements are mounted near the sidewall outside of the radially outer extent of the motor.

17. The heater of claim 11, further comprising a temperature sensor within the housing configured to sense temperature within the housing, the controller configured to control power to the heating elements being based on the sensed temperature within the housing.

18. The heater of claim 11, wherein an interior surface of the sidewall comprises a polygonal cross-sectional shape having side surfaces and vertices that help to direct swirling air from the fan over the heating elements.

19. The heater of claim 11, wherein the heater comprises a conical deflector at the second end within the housing to divert heated air radially outwardly through the outlet.

20. The heater of claim 11, wherein the controller is programmed to control current delivered to the heating elements to provide heated air of about 130° to about 140° Fahrenheit for the duration sufficient to eradicate insects.
